(19) United States
(12) Patent Application Publication
(10) Pub. No.: US 2012/0317500 A1
(43) Pub. Date: Dec. 13, 2012

(54) SYSTEM AND METHOD FOR DATA VISUALIZATION AND USER COLLABORATION

(75) Inventors: Mario KOSSEIFI, Roswell, GA (US); Syed AFTAB, Budd Lake, NJ (US); Michael ORTH, Edison, NJ (US)

(73) Assignees: AT&T INTELLECTUAL PROPERTY I, L.P., Atlanta, GA (US); AT&T MOBILITY II LLC, Atlanta, GA (US)

(21) Appl. No.: 13/154,861

(22) Filed: Jun. 7, 2011

(51) Int. Cl. G06F 3/01; G06F 15/16

(52) U.S. Cl. 715/753

(57) ABSTRACT

A non-transitory computer-readable medium stores a program for visualizing data. The program includes code for visualizing data, and code for enabling communication between users of the program.

### BACKGROUND

1. Field of the Disclosure

The present disclosure relates to data visualization. More particularly, the present disclosure relates to a system which visualizes data and enables collaboration between system users.

2. Background Information

Various software programs currently exist which perform data visualization. For example, there are programs which visualize network data, scientific data, industrial data, business data, financial data and/or other statistical data. Some of these programs are desktop-based, and others are web-based (i.e., are accessed by connection to a web server).

However, it is difficult for users of conventional data visualization programs to capture information as they see it and to communicate that information to colleagues. To collaborate with colleagues, a user must communicate with methods such as email, online conference, telephone, etc. Due to the large volume of data that may be available, and the subjective nature of visually interpreting data, this may consume a substantial amount of time.

### BRIEF DESCRIPTION OF THE DRAWINGS

FIG. 1 shows an example of a general computer system that may execute a data visualization program, as described herein;

FIG. 2 shows a functional diagram of an example of a data visualization program according to the present disclosure; and

FIG. 3 illustrates an example of a data network utilizing a data visualization program according to the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

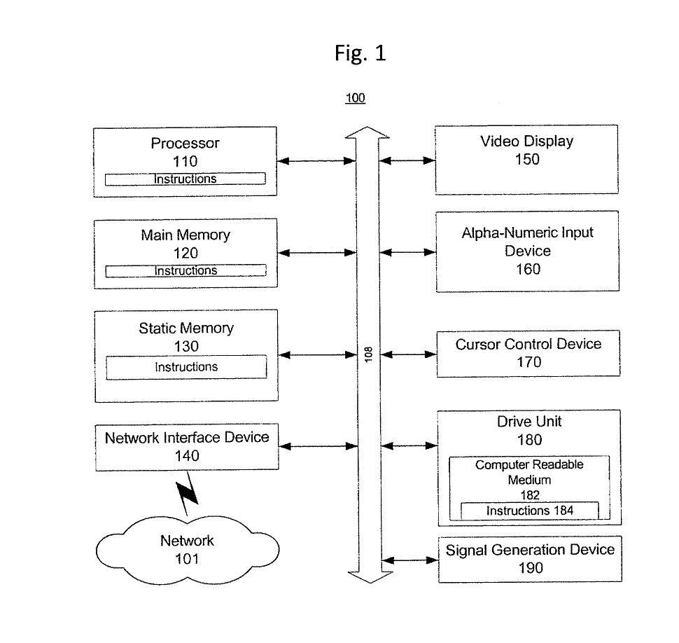

FIG. 1 is an illustrative embodiment of a general computer system that may include a set of instructions for performing processes as described herein. The general computer system is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices. For example, the computer system 100 may include or be included within any one or more of the computers, servers, systems, or communication networks described herein.

In a networked deployment, the computer system may operate in the capacity of a server or as a client user computer in a server-client user network environment, or as a peer computer system in a peer-to-peer (or distributed) network environment. The computer system 100, or portions thereof, can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an alpha-numeric input device 160, such as a keyboard, another input device (not shown), such as a remote control device having a wireless keypad, a keyboard, a microphone coupled to a speech recognition engine, a camera such as a video camera or still camera, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible, non-transitory article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

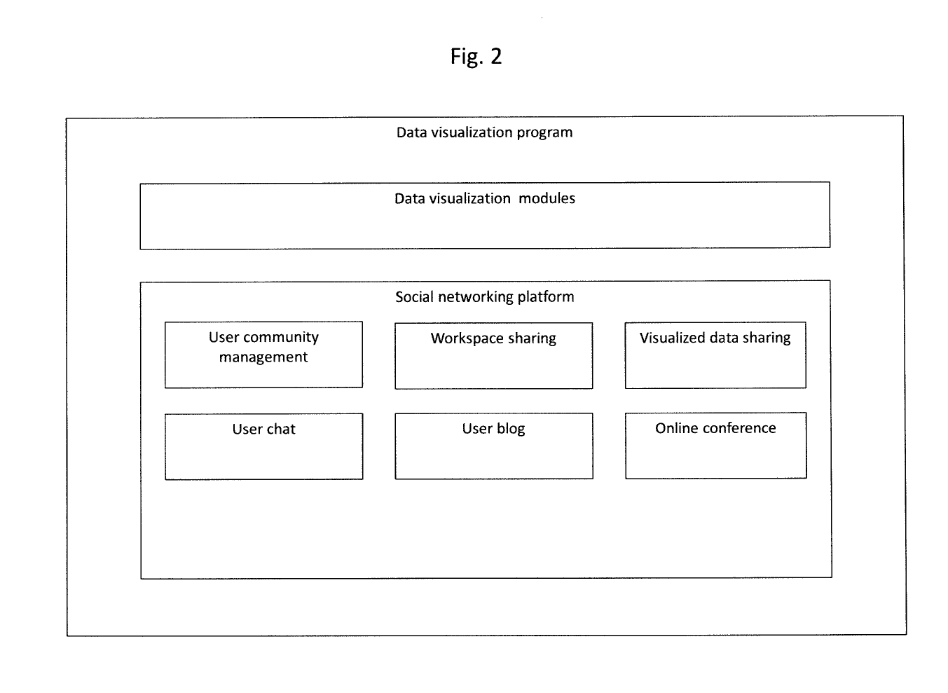

FIG. 2 illustrates a functional diagram of an example of a data visualization program according to the present disclosure. The data visualization program illustrated in FIG. 2 includes data visualization modules which include code for visualizing data, and a social networking platform which includes code for enabling communication between users of the data visualization program.

The data visualization modules visually present various types of data through graphical display. It should be noted that the present disclosure is not limited to a specific type of data. Examples of data which may be visualized by the program include, but is not limited to, network data (such as wireless network performance data), scientific data, industrial data, business data, financial data and/or other statistical data

The social networking platform of the data visualization program may be especially beneficial for applications in which interaction between users is strongly desired, such as in troubleshooting network issues. The social networking platform may interact with the data visualization modules to enable a user to capture and communicate visualized data, such as data representing network anomalies. Using the social networking platform, a user may capture an issue as they see it, and broadcast it to other users.

Web or server based tools may be added to the data visualization program via an application programming interface (API) or other mechanisms. The tools may be accessed via HTTP, Telnet, FTP, or other application layer protocols.

As shown in FIG. 2, the social networking platform may include a user community management module which includes code for enabling a user to define a community including a specified group of users, and code for enabling communication between users in the community. With this module, a user may create a networking profile and a community, and add users to the community. The community may be a group of users working on a common issue, such as markets, care, churn analysis, performance issues, outages, etc.

The social networking platform may also include a workspace sharing module which includes code for enabling a first user of the program to view, on a first terminal, a workspace which is viewed by a second user of the program on a second terminal. Thus, through the data visualization program, a user can view on his terminal the workspace of another user, thereby allowing the two users to view the same visualization data.

The social networking platform may also include a visualized data sharing module which includes code for enabling a first user of the program to share visualized data with a second user of the program. In this regard, this module may enable a user to take a snapshot of the data viewed on the user's workspace, and send the snapshot to other users. The module may also enable a user to capture and share video, animated call detail records, tickets, or logs.

The social networking platform may also include a user chat module which includes code for enabling a first user of the program to chat with a second user of the program in real-time. With this module, a user may initiate a chat session open to all users of the data visualization program, a session open only to a predefined community, or a session with only a specific individual.

The social networking platform may also include a user blog module which includes code for enabling a user of the program to create and update a blog viewable by other users of the program. With this module, a user may create a blog directed towards a topic of interest to members of a specific user community, which may be accessible only to users of the community, or may create a blog accessible to all users of the data visualization program.

The social network platform may also include an online conference module which includes code for enabling a user of the program to start or join an online conference between users of the program. The online conference may be an audio conference or a video conference, and may be accessible to all users of the data visualization program, all users in a predefined community, or to selected individuals.

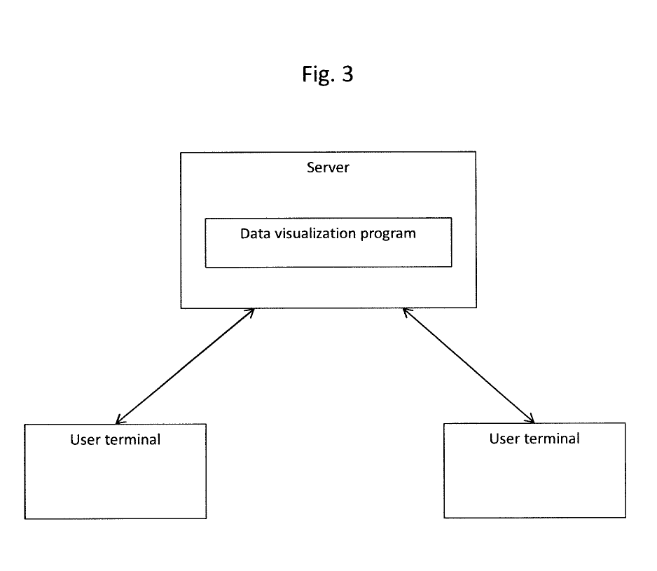

FIG. 3 illustrates an example of a data network utilizing a data visualization program according to the present disclosure. The data visualization program may be web-based, and thus, as shown in FIG. 3, the program may be stored on and executed by a web server, and accessed by user terminals that connect to the server.

The user terminals are electronic devices having the capability to connect to the server through a network. Examples of user terminals include, but are not limited to, desktops, laptops, smartphones, tablet devices, and set-top boxes. The user terminals may connect to the server through a local connection, such as, but not limited to, a local area network (LAN) or wireless LAN (WLAN), or through a remote connection, such as, but not limited to a wide area network (WAN), the Internet, or a cellular network.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

According to an aspect of the present disclosure, a non-transitory computer-readable medium stores a program for visualizing data. The program includes code for visualizing data, and code for enabling communication between users of the program.

The program may be a web-based program. The code for enabling communication between users may include code for enabling a user of the program to define a community including a specified group of users of the program, and code for enabling communication between users in the community. The code for enabling communication between users of the program may include code for enabling a first user of the program to view, on a first terminal, a workspace which is viewed by a second user of the program on a second terminal.

The code for enabling communication between users of the program may include code for enabling a first user of the program to share visualized data with a second user of the program. The code for enabling communication between users of the program may include code for enabling a first user of the program to chat with a second user of the program in real-time. The code for enabling communication between users of the program may include code for enabling a user of the program to create and update a blog viewable by other users of the program.

According to another aspect of the present disclosure, a computer system for visualizing data includes at least one server configured to execute a program for visualizing data, and enable communication between users of the program, via the program.

The program may be a web-based program. The program may enable a user of the program to define a community including a specified group of users of the program, and enable communication between users in the community. The program may enable a first user of the program to view, on a first terminal, a workspace which is viewed by a second user of the program on a second terminal.

The program may enable a first user of the program to share visualized data with a second user of the program. The program may enable a first user of the program to chat with a second user of the program in real-time. The program may enable a user of the program to create and update a blog viewable by other users of the program.

According to another aspect of the present disclosure, a method for visualizing data includes executing a program for visualizing data, and enabling communication between users of the program, via the program.

The program may be a web-based program. The method may include defining a community including a specified group of users of the program, via the program, and enabling communication between users in the community. The method may also include enabling a first user of the program to view, on a first terminal, a workspace which is viewed by a second user of the program on a second terminal.

The method may include enabling a first user of the program to share visualized data with a second user of the program. The method may also include enabling a first user of the program to chat with a second user of the program in real-time.

While a computer-readable medium herein may be shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for power over ethernet represent an example of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A non-transitory computer-readable medium which stores a program for visualizing data, the program comprising:
code for visualizing data; and
code for enabling communication between users of the program.

2. A computer-readable medium according to claim 1, wherein the program is a web-based program.

3. A computer-readable medium according to claim 1, wherein the code for enabling communication between users comprises:
code for enabling a user of the program to define a community comprising a specified group of users of the program; and
code for enabling communication between users in the community.

4. A computer-readable medium according to claim 1, wherein the code for enabling communication between users of the program comprises code for enabling a first user of the program to view, on a first terminal, a workspace which is viewed by a second user of the program on a second terminal.

5. A computer-readable medium according to claim 1, wherein the code for enabling communication between users of the program comprises code for enabling a first user of the program to share visualized data with a second user of the program.

6. A computer-readable medium according to claim 1, wherein the code for enabling communication between users of the program comprises code for enabling a first user of the program to chat with a second user of the program in real-time.

7. A computer-readable medium according to claim 1, wherein the code for enabling communication between users of the program comprises code for enabling a user of the program to create and update a blog viewable by other users of the program.

8. A computer system for visualizing data, the computer system comprising at least one server configured to:
execute a program for visualizing data; and
enable communication between users of the program, via the program.

9. A computer system according to claim 8, wherein the program is a web-based program.

10. A computer system according to claim 8, wherein the program enables a user of the program to define a community comprising a specified group of users of the program, and enables communication between users in the community.

11. A computer system according to claim 8, wherein the program enables a first user of the program to view, on a first terminal, a workspace which is viewed by a second user of the program on a second terminal.

12. A computer system according to claim 8, wherein the program enables a first user of the program to share visualized data with a second user of the program.

13. A computer system according to claim 8, wherein the program enables a first user of the program to chat with a second user of the program in real-time.

14. A computer system according to claim 8, wherein the program enables a user of the program to create and update a blog viewable by other users of the program.

15. A method for visualizing data, comprising:
executing a program for visualizing data; and
enabling communication between users of the program, via the program.

16. A method according to claim 15, wherein the program is a web-based program.

17. A method according to claim 15, further comprising:
defining a community comprising a specified group of users of the program, via the program; and
enabling communication between users in the community.

18. A method according to claim 15, further comprising enabling a first user of the program to view, on a first terminal, a workspace which is viewed by a second user of the program on a second terminal.

19. A method according to claim 15, further comprising enabling a first user of the program to share visualized data with a second user of the program.

20. A method according to claim 15, further comprising enabling a first user of the program to chat with a second user of the program in real-time.
